(19) United States
(12) Patent Application Publication
(10) Pub. No.: US 2025/0192356 A1
(43) Pub. Date: Jun. 12, 2025

(54) BATTERY PACK VENTING SYSTEM AND VENTING METHOD

(71) Applicant: Ford Global Technologies, LLC, Dearborn, MI (US)

(72) Inventors: Patrick Roxin, Livonia, MI (US); Alex Revels, Canton, MI (US); Kanchana Perumalla, Troy, MI (US); Antony George Schepak, Howell, MI (US); Sara Buchel, Fenton, MI (US)

(21) Appl. No.: 18/760,668

(22) Filed: Jul. 1, 2024

Related U.S. Application Data
(60) Provisional application No. 63/607,888, filed on Dec. 8, 2023.

(51) Int. Cl. H01M 50/367; H01M 50/249; H01M 50/298

(52) U.S. Cl. CPC H01M 50/367; H01M 50/249; H01M 50/298

(57) ABSTRACT

A battery pack venting system includes a battery pack enclosure providing an interior, and a cell stack within the interior. The cell stack includes one or more battery cells disposed along a cell stack axis. One or more structural members are disposed within the interior alongside an axial end portion of the cell stack. Each structural member including at least one channel. A shield is within the interior. The shield has a recess configured to receive vent byproducts released from the one or more battery cells. The shield is configured to redirect the vent byproducts into the at least one channel.

### CROSS-REFERENCE TO RELATED APPLICATIONS

This disclosure claims the benefit of U.S. Provisional Application No. 63/607,888, which was filed on Dec. 8, 2023, and is incorporated herein by reference in its entirety.

### TECHNICAL FIELD

This disclosure relates generally to traction battery packs and, more particularly, to communicating vent byproducts from battery cells to an area outside the battery pack.

### BACKGROUND

Electrified vehicles include a traction battery pack for powering electric machines and other electrical loads of the vehicle. The traction battery pack can include a plurality of battery cells and various other battery internal components that support electric vehicle propulsion.

### SUMMARY

In some aspects, the techniques described herein relate to a battery pack venting system, including: a battery pack enclosure providing an interior; a cell stack within the interior, the cell stack including one or more battery cells disposed along a cell stack axis; one or more structural members disposed within the interior alongside an axial end portion of the cell stack, each structural member including at least one channel; and a shield within the interior, the shield having a recess configured to receive vent byproducts released from the one or more battery cells, the shield configured to redirect the vent byproducts into the at least one channel.

In some aspects, the techniques described herein relate to a battery pack venting system, wherein the one or more structural members each extend along a structural member axis that is transverse to the cell stack axis.

In some aspects, the techniques described herein relate to a battery pack venting system, wherein the shield extends longitudinally along a shield axis that is transverse to the structural member axis.

In some aspects, the techniques described herein relate to a battery pack venting system, wherein the structural member axis is perpendicular to the cell stack axis and the shield axis.

In some aspects, the techniques described herein relate to a battery pack venting system, wherein the one or more structural members are one or more extruded structural members.

In some aspects, the techniques described herein relate to a battery pack venting system, wherein the one or more structural members each spans a plurality of cell stacks.

In some aspects, the techniques described herein relate to a battery pack venting system, wherein the shield extends outward to overlap an opening to the at least one channel of the one or more structural members.

In some aspects, the techniques described herein relate to a battery pack venting system, wherein the one or more structural members includes a first structural member on a driver side of the cell stack, and a second structural member on a passenger side of the cell stack, the shield and the recess extending laterally outward to overlap an opening to a first channel of the first structural member and to overlap an opening to a second channel of the second structural member.

In some aspects, the techniques described herein relate to a battery pack venting system, further including at least one control module within the interior, the shield disposed between the at least one control module and the cell stack.

In some aspects, the techniques described herein relate to a battery pack venting system, wherein the shield is polymer-based.

In some aspects, the techniques described herein relate to a battery pack venting system, wherein the shield includes a notch configured to receives wiring.

In some aspects, the techniques described herein relate to a battery pack venting system, further including a frame member disposed along a side of the cell stack, the frame member including a plurality of frame openings that communicate the vent byproducts to the recess.

In some aspects, the techniques described herein relate to a battery pack venting system, wherein the shield is adhesively secured to the frame member.

In some aspects, the techniques described herein relate to a battery pack venting method, including: receiving a flow of vent byproducts discharged from one or more battery cells of a cell stack within a recess of a shield, the flow discharged radially away from a cell stack axis of the cell stack; and redirecting a flow of vent byproducts along the cell stack and into a channel of a structural member.

In some aspects, the techniques described herein relate to a battery pack venting method, further including overlapping an opening to the channel with the recess of the shield.

In some aspects, the techniques described herein relate to a battery pack venting method, wherein the redirecting redirects some of the flow to a first channel on a driver side of the cell stack and some of the flow to a second channel on a passenger side of the cell stack.

In some aspects, the techniques described herein relate to a battery pack venting method, wherein the structural member spans a plurality of cell stacks.

In some aspects, the techniques described herein relate to a battery pack venting method, wherein the flow passes from the one or more battery cells through a frame opening in a frame member prior to reaching the recess in the shield.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates a perspective and partially expanded view of selected portions of the battery pack of FIG. 1.

FIG. 3 illustrates a close-up and expanded view of an area of the battery pack of FIG. 2.

FIG. 4 illustrates a close-up view of an area of the battery pack of FIG. 2.

FIG. 5 illustrates an overhead schematic view of a forward portion of the battery pack of FIG. 2 with an enclosure cover removed.

FIG. 6 illustrates a perspective view of a forward side of the shield.

FIG. 7 illustrates a perspective view of a backside of the shield showing a recess within the shield.

### DETAILED DESCRIPTION

This disclosure details exemplary systems and methods utilized to communicate vent byproducts emitted from battery cells to an area outside a battery pack enclosure. The systems and methods involve using a shield to redirect the vent byproducts into channels provided by structural members within the battery pack enclosure. After passing through the channels, the vent byproducts can be communicated through a battery pack vent to an area outside the battery pack enclosure. These and other features are discussed in greater detail in the following paragraphs.

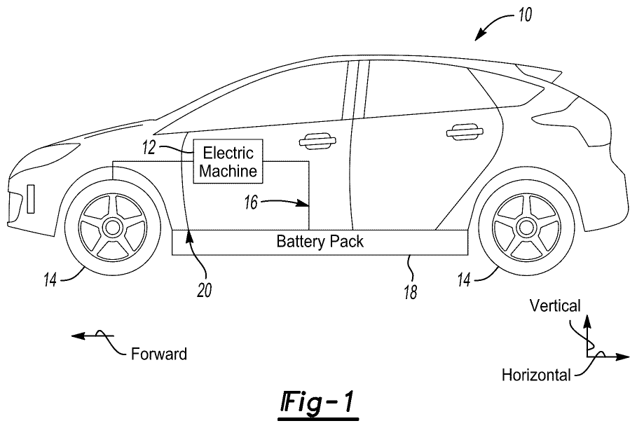

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 electrically couples the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 is secured to an underbody 20 of the electrified vehicle 10. However, the traction battery pack 18 could be located elsewhere on the electrified vehicle 10 in other examples.

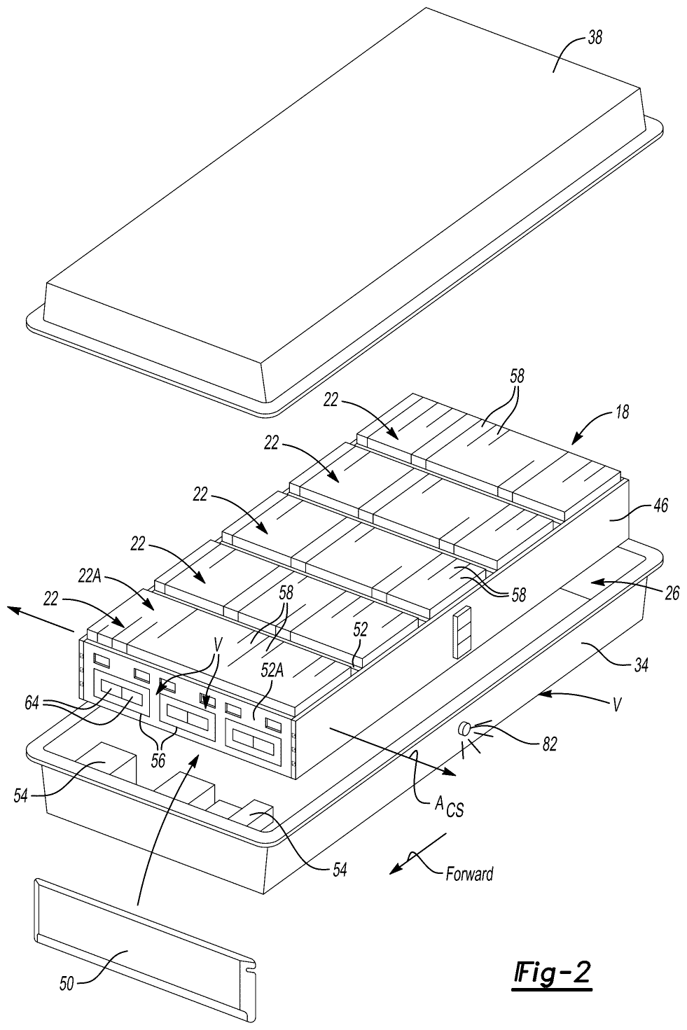

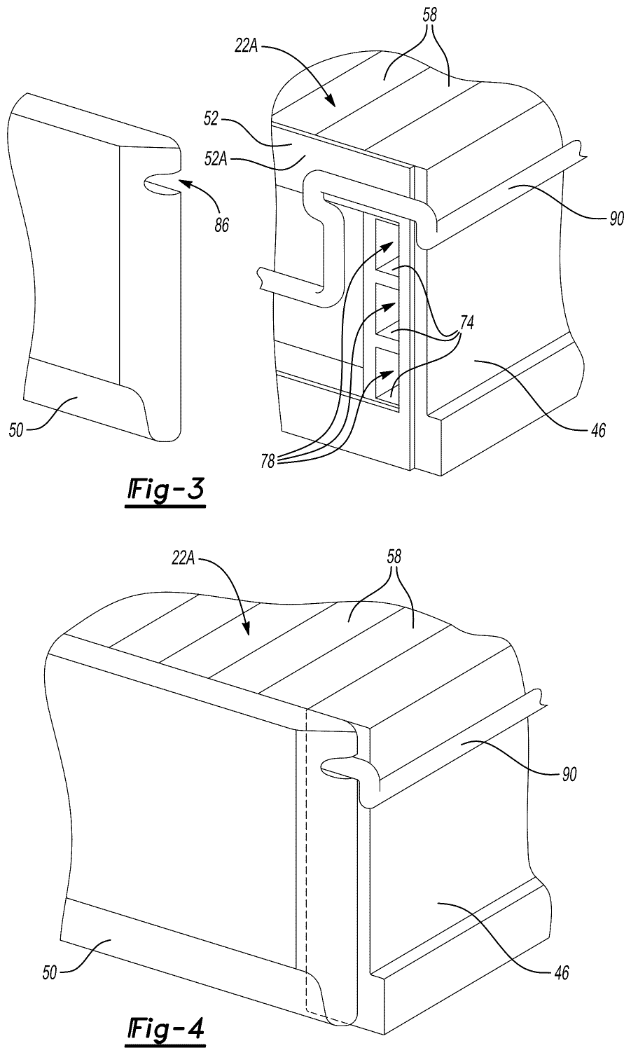

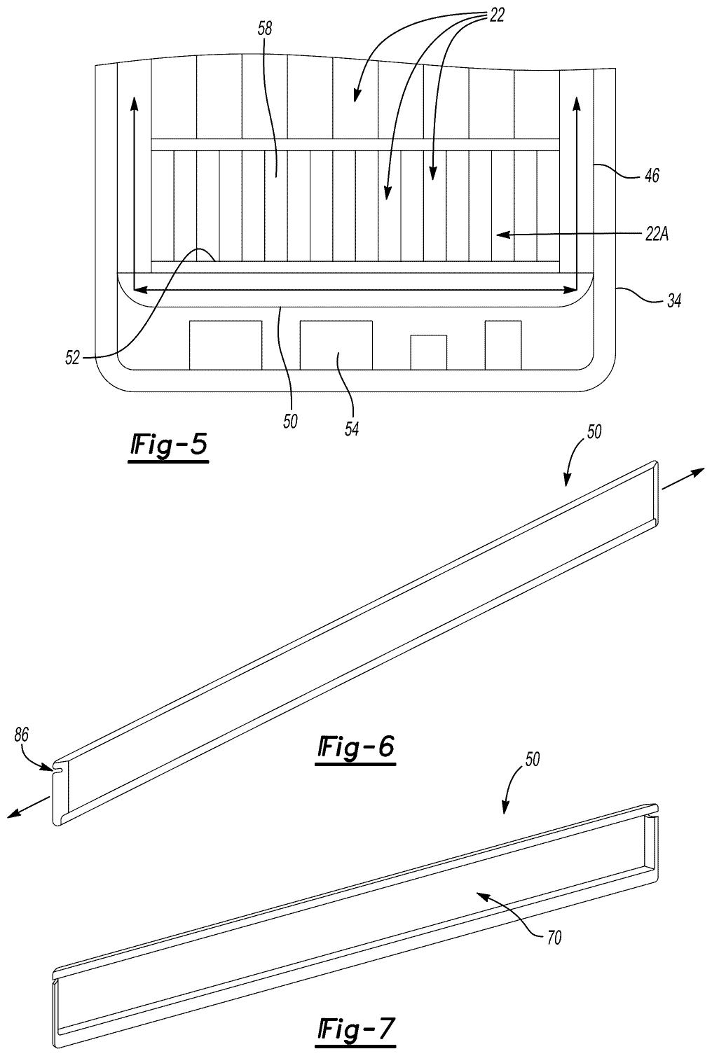

With reference to FIGS. 2-7, the traction battery pack 18 includes a plurality of cell stacks 22 housed within an interior 26 of an enclosure assembly 30, which includes an enclosure tray 34 and an enclosure cover 38. The enclosure tray 34 and the enclosure cover 38 cooperate to provide the interior 26 that houses the cell stacks 22. In this example, structural members 46, a shield 50, crossmember assemblies 52, and at least one control module 54 are housed within the interior 26 together within the interior 26.

In the exemplary embodiment, the cell stacks 22 are disposed within the enclosure tray 34—the enclosure cover 38 is then secured to the enclosure tray 34 to enclose the cell stacks 22 and other battery internal components within the interior 26. Although a specific number of the cells stacks 22 are illustrated in the various figures of this disclosure, the traction battery pack 18 could include any number of the cell stacks 22.

Each cell stack 22 includes a plurality of battery cells 58 stacked side-by-side relative to each other along a cell stack axis A_{CS}. The battery cells 58 store and supply electrical power for powering various components of the electrified vehicle 10. The cell stacks 22 can additionally include various dividers, thermal interface materials, adhesives, and other materials between the individual battery cells 58.

In the exemplary embodiment, the battery cells 58 are lithium-ion pouch style battery cells. However, battery cells having other geometries (cylindrical, prismatic, etc.) and/or chemistries (nickel-metal hydride, lead-acid, etc.) could alternatively be used within the scope of this disclosure.

The crossmember assemblies 52 are disposed between cell stacks 22 within the interior 26. In this example, the cell stacks 22 and the crossmember assemblies 52 extend longitudinally in a cross-vehicle direction of the electrified vehicle 10. The crossmember assemblies 52 and the cell stacks 22 span from one of the structural members 46 on a driver side of the traction battery pack 18 to another of the structural members 46 on a passenger side of the battery pack 18.

Among other functions, the crossmember assemblies 52 can be configured to help hold the battery cells 58 of the cell stacks 22 and at least partially delineate the cells stacks 22 from one another within the interior 26. The example crossmember assemblies 52 include busbars 56 and vent openings 60. The crossmember assemblies 52 can be considered ladder frames. The crossmember assemblies 52 can include pultruded portions.

In the exemplary embodiment, the structural members 46 are oriented along a length of the vehicle 10 and are thus, in this example, arranged transversely to the crossmember assemblies 52 and the cell stack 22. The structural members 46 span over axial end portions of the cell stacks 22 and the crossmember assemblies 52. The crossmember assemblies 52 can interface with the structural members 46 to accommodate tension loads resulting from expansion and retraction of the battery cells 58 along the cell stack axes A_{CS}.

In this example, the structural members 46 are extruded structures. The structural members 46 can be extruded aluminum, for example. A person having skill in this art would be able to structurally distinguish an extruded structure from a structure that is not extruded.

The battery cells 58, in this example, include tab terminals 64 that project outwardly from a battery cell housing through openings to connect to a busbar 56 of the crossmember assembly 52. In some examples, the tab terminals 64 extend through the vent openings 60. In other examples, as here, the tab terminals 64 extend through other openings.

From time to time, pressure and thermal energy within at least one of the battery cells 58 in the cell stacks 22 can increase. This can lead to the battery cell 58 discharging a flow of vent byproducts V, which can include gas and debris, from within the battery cell 58. The vent byproducts V can be discharged from the battery cell 58 through designated cell vent within a housing of the battery cell 58. The cell vent can be a membrane that yields in response to increased pressure and thermal energy within the battery cell 58. The cell vent can instead be a ruptured area of the battery cell 58. Vent byproducts V can be discharged from the battery cells 58 forward though one or more of the vent openings 60.

In the exemplary embodiment, the shield 50 is disposed in a forward portion of the traction battery pack 18 between the forwardmost crossmember assembly 52A and the at least one control module 54 with the shield axis A_{S} parallel to the cell stack axes A_{CS} and the longitudinal axes of the crossmember assemblies 52. Should one of the battery cells 58 in the cell stack 22A at the forwardmost position within the traction battery pack 18 vent, the vent byproducts V can be discharged through one or more of the vent openings 60 in the forwardmost crossmember assembly 52 toward the shield 50.

The shield 50 has a recess 70 that receives the vent byproducts V released from the battery cells 58. The shield 50 redirects the vent byproducts V received within the recess 70 laterally outward toward the structural members 46.

The shield 50 and the recess 70 each extend laterally outward to overlap openings 74 to channels 78 within the structural members 46. The vent byproducts V that have moved into the recess 70 and been directed laterally outward flow from the recess 70 into one of the openings 74 and into the channels 78 of the structural members 46. The vent byproducts V move within the channels 78 along a longitudinal axis of the respective structural member 46. Thermal energy from within the vent byproducts V can reduced as the vent byproducts V move through the recess 70 and the channel 78.

After moving through at least a portion of the channel 78, the vent byproducts V can be communicated from the channel 78 to a vent 82 of the traction battery pack 18. The vent 82 releases the vent byproducts V to an area outside the enclosure assembly 30 of the traction battery pack 18.

The shield 50 can be a polymer-based shield. The shield 50 helps to block the vent byproducts V from impinging directly on, among other things, the at least one control module 54, which could potentially inhibit operation of the control module 54. Example control modules 54 can include a Battery Energy Control Module (BECM), Bussed Electrical Center (BEC), Battery Pack Sensor Module (BPSM), etc. The shield 50 can block the vent byproduct V from impinging on other components, such as coolant hoses, busbars, Electrical Data System (EDS) harnesses, circuit breakers, current sensors, pressure sensors, etc.

The shield 50 can be adhesively secured to the structural member 46 in the forwardmost position of the traction battery pack 18. The shield 50 covers the respective openings 60 in that structural member 46. The shield 50, in this example, includes a notch 86 that is provided to accommodate wiring 90 when the shield 50 is in the installed position. The wiring 90 can extend through the recess 70 to an area outside the recess 70. The wiring 90 can be, for example, operably coupled to a busbar sensing module.

Features of the disclosed examples include lengthening a time vent byproducts move through an interior of a battery pack prior to being exhausted from the battery pack.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack venting system, comprising:
a battery pack enclosure providing an interior;
a cell stack within the interior, the cell stack including one or more battery cells disposed along a cell stack axis;
one or more structural members disposed within the interior alongside an axial end portion of the cell stack, each structural member including at least one channel; and
a shield within the interior, the shield having a recess configured to receive vent byproducts released from the one or more battery cells, the shield configured to redirect the vent byproducts into the at least one channel.

2. The battery pack venting system of claim 1, wherein the one or more structural members each extend along a structural member axis that is transverse to the cell stack axis.

3. The battery pack venting system of claim 2, wherein the shield extends longitudinally along a shield axis that is transverse to the structural member axis.

4. The battery pack venting system of claim 3, wherein the structural member axis is perpendicular to the cell stack axis and the shield axis.

5. The battery pack venting system of claim 1, wherein the one or more structural members are one or more extruded structural members.

6. The battery pack venting system of claim 1, wherein the one or more structural members each spans a plurality of cell stacks.

7. The battery pack venting system of claim 1, wherein the shield extends outward to overlap an opening to the at least one channel of the one or more structural members.

8. The battery pack venting system of claim 1, wherein the one or more structural members includes a first structural member on a driver side of the cell stack, and a second structural member on a passenger side of the cell stack, the shield and the recess extending laterally outward to overlap an opening to a first channel of the first structural member and to overlap an opening to a second channel of the second structural member.

9. The battery pack venting system of claim 1, further comprising at least one control module within the interior, the shield disposed between the at least one control module and the cell stack.

10. The battery pack venting system of claim 1, wherein the shield is polymer-based.

11. The battery pack venting system of claim 1, wherein the shield includes a notch configured to receives wiring.

12. The battery pack venting system of claim 1, further comprising a frame member disposed along a side of the cell stack, the frame member including a plurality of frame openings that communicate the vent byproducts to the recess.

13. The battery pack venting system of claim 12, wherein the shield is adhesively secured to the frame member.

14. A battery pack venting method, comprising:
receiving a flow of vent byproducts discharged from one or more battery cells of a cell stack within a recess of a shield, the flow discharged radially away from a cell stack axis of the cell stack; and
redirecting a flow of vent byproducts along the cell stack and into a channel of a structural member.

15. The battery pack venting method of claim 14, further comprising overlapping an opening to the channel with the recess of the shield.

16. The battery pack venting method of claim 15, wherein the redirecting redirects some of the flow to a first channel on a driver side of the cell stack and some of the flow to a second channel on a passenger side of the cell stack.

17. The battery pack venting method of claim 14, wherein the structural member spans a plurality of cell stacks.

18. The battery pack venting method of claim 14, wherein the flow passes from the one or more battery cells through a frame opening in a frame member prior to reaching the recess in the shield.
